(19) United States
(12) Patent Application Publication
(10) Pub. No.: US 2009/0248533 A1
(43) Pub. Date: Oct. 1, 2009

(54) SYSTEMS AND METHODS FOR CONDUCTING TRANSACTIONS

(75) Inventors: Matthew Donald Colemen, Rothesay Bay (NZ); Bradley Hanan Carter, Onerahi (NZ); Paul Johnston, Milford (NZ); Clive Malcolm Lewis, Takapuna (NZ)

Correspondence Address: HAMRE, SCHUMANN, MUELLER & LARSON, P.C., P.O. BOX 2902, MINNEAPOLIS, MN, 55402-0902, US

(73) Assignee: Txttunes Limited, Onehunga (NZ)

(21) Appl. No.: 12/059,597

(22) Filed: Mar. 31, 2008

(51) Int. Cl. G06Q 30/00; G06Q 20/00

(52) U.S. Cl. 705/26; 705/1; 705/35

(57) ABSTRACT

Methods and systems for conducting a transaction which relate to receiving a transaction request from a transaction object containing a region identifier and a mobile device identifier. A short code is identified in a short code database based on the region identifier. A confirmation request message is transmitted to a mobile device corresponding to the mobile device identifier, where the confirmation request message includes a reply address corresponding to the short code.

### FIELD

The described embodiments relate to systems and methods for conducting a transaction, and in particular, to systems and methods for conducting a transaction by receiving a transaction request from a transaction object and sending a confirmation request message to a mobile device.

### BACKGROUND

Embodiments of the invention relate to systems and methods for conducting a transaction. A simplified example transaction may involve a purchaser making a transaction request for an item, such as a request to purchase a product or service. The purchaser makes or authorizes payment for the item related to the transaction request and the item is delivered to the purchaser.

Known systems and methods for conducting a transaction require a purchaser to rely on various financial instruments such as credit cards, debit cards, smart cards, currency and cheques to make or authorize payment for the transaction. The Internet and other communication networks may be utilized for conducting a transaction, and these financial instruments may have limitations when using a communication network.

For example, currency and cheques are not commonly available in an electronic format making payment difficult when using the communication network. While providing credit card, debit card or other payment information may enable payment in an electronic format, security concerns arise when using a communication network such as the internet. Payment using credit and debit card may be too expensive for small payment amounts. Purchasers may also not be qualified for, or desirous of obtaining a credit or debit card.

Mobile devices are widely used around the world by users of all ages. Mobile devices have become an integral part of daily life and a user may carry a mobile device with them as commonly as keys or a wallet. The Global System for Mobile (GSM) communication is an international mobile device standard, which allows a user to use their mobile device in many geographical regions and countries worldwide.

Numerous independent mobile device carriers maintain mobile networks in different geographical regions or countries implementing the GSM standard enabling a user's mobile device to roam on these mobile networks worldwide. A specific carrier typically maintains an account linked to a specific mobile device and/or an associated user. An account typically includes user information, payment information, billing information, and other private information associated with the mobile device and/or user.

Carriers generally operate independently and are each responsible for issuing a bill in relation to usage by a mobile device (or a user associated therewith) on an associated mobile network. In turn, a user provides payment for the bill. That is, there exists a billing and payment system that enable carriers to issue a bill and receive payment for usage of mobile devices associated therewith.

Mobile devices have the ability to send and receive text and data messages using services such as the Short Message Service (SMS), herein referred to as SMS messages. SMS messages are composed of text characters and may contain up to 160 characters for Latin alphabets. Basic mobile devices have SMS message capabilities and a mobile device is not required to have Wireless Application Protocol (WAP) capabilities or other complex (and often expensive) features in order to send an SMS message. Multimedia Messaging Service (MMS) is another mobile messaging service that allows mobile devices to send messages that include multimedia objects (e.g. images, audio, video, rich text) in addition to text.

A mobile device may send an SMS or MMS message to a destination number such as a phone or mobile device number having a regular 10-digit format. A mobile device may also send an SMS or MMS message to a short code. A short code is similar to a phone or mobile device number in that it is used as a destination address for a message, much like a url in the context of the internet.

The short code allows a premium rate (price) to be charged to the user's mobile device account or bill, as maintained and issued by a carrier. The user is generally charged when the message is sent to the short code. The premium rate to charge for an SMS or MMS message sent to the short code is typically determined by a carrier it is assigned (or leased) to or a third party in agreement with the carrier.

Typically, short codes, or ranges of short codes, are exclusively assigned (or leased) to a carrier and the assigned short code will only be recognizable to the specific carrier. Only mobile devices that are associated with the carrier are able to successfully send an SMS or MMS message to the assigned short code.

The short code is often in a shorter digit format than a regular phone number. The digit format of the short code varies between regions and countries. For example, in Australia short codes are six or eight digits in length, starting with the prefix “19” followed by an additional four or six digits. In the United Kingdom, short codes are five digits in length, generally starting with a six or eight. In Canada, short codes are five or six digits in length. Since the digit format of short codes varies from region to region, an SMS or MMS message sent to a short code may be unrecognizable by a carrier in one region if the digit format corresponds to a different region.

As short codes are linked to specific carriers and regions, a worldwide mobile device user cannot simply use one short code for all carriers and regions. The mobile device user must be diligent in determining an appropriate short code to use.

Some known systems and methods for conducting a transaction involve marketing services and/or products using a short code. For example, a short code may be displayed in an advertisement for services and/or products. Upon viewing the advertisement, a purchaser must initiate the transaction by sending an SMS message to the short code using a mobile device.

These known systems and methods require knowledge by the user of the specific short code and require the user to initiate the transaction using their mobile device. If a user desires to purchase a product viewed on e.g. a web page displayed on a computing device then they are required to initiate the transaction using their mobile phone. A user must determine the appropriate short code and initiate the transaction outside of the web page, which may not provide a seamless transaction process. The user may also be required to identify the product in the message.

Further, if the advertised short code is not recognizable by a carrier or region associated with the user's mobile device then the transaction cannot be conducted or initiated.

Accordingly, known systems and methods for conducting a transaction involving a short code are limited to a specific carrier or region and are typically not available for worldwide mobile device users. There is a need for systems and methods of conducting a transaction that alleviate some of the shortcomings of known systems and methods or at least provide for a useful alternative.

### SUMMARY

In a first aspect, some embodiments of the invention provide a method for conducting a transaction. The method comprises receiving a transaction request from a transaction object containing a region identifier and a mobile device identifier; identifying a short code based on the region identifier; and transmitting a confirmation request message to a mobile device corresponding to the mobile device identifier, wherein the confirmation request message includes a reply address corresponding to the short code.

In another aspect, some embodiments of the invention provide a method where the transaction request also contains a carrier system identifier and where the short code is identified based on both the region identifier and the carrier system identifier.

In another aspect, some embodiments of the invention provide a method further comprising receiving a reply message corresponding to the confirmation request message and to the short code; and authorizing the transaction in response to the reply message.

In another aspect, some embodiments of the invention provide a method where the transaction relates to electronically deliverable content available from a content server. The method further comprises receiving a reply message corresponding to the confirmation request message and to the short code; transmitting electronic content delivery instructions to the content server; and transmitting a transaction authorization message to the transaction object.

In another aspect, some embodiments of the invention provide a method where the transaction relates to electronically deliverable content. The method further comprises receiving a reply message corresponding to the confirmation request message and to the short code; transmitting a transaction authorization message to the transaction object, wherein the transaction authorization message instructs the transaction object to deliver the content to a purchaser.

In another aspect, some embodiments of the invention provide a method where the transaction relates to electronically deliverable content. The method further comprises receiving a reply message corresponding to the confirmation request message and to the short code; and transmitting a transaction authorization message to the transaction object, wherein the transaction authorization message includes a link to the electronically deliverable content.

In another aspect, some embodiments of the invention provide a method where the transaction relates to a physically deliverable item. The method further comprises receiving a reply message corresponding to the confirmation request message and to the short code; and initiating delivery of the item to a purchaser.

In another aspect, some embodiments of the invention provide a method further comprising assigning a transaction identifier to the transaction request; recording the transaction in a transaction database; and identifying the transaction as an open transaction.

In another aspect, some embodiments of the invention provide a method further comprising receiving a reply message corresponding to the confirmation request message and to the short code; identifying the transaction corresponding to the confirmation request message as a closed transaction.

In another aspect, some embodiments of the invention provide a method where the confirmation request message includes a transaction identifier.

In another aspect, some embodiments of the invention provide a method where the confirmation request message includes a transaction identifier, and where the reply message includes the transaction identifier.

In another aspect, some embodiments of the invention provide a method where the transaction object is embedded within a merchant web page rendered on a customer device.

In another aspect, some embodiments of the invention provide a method where the carrier system identifier corresponds to a carrier system, and where the short code corresponds to a transaction cost for charging an account associated with the mobile device maintained by the carrier system.

In another aspect, some embodiments of the invention provide a method further comprising receiving a reply message corresponding to the confirmation request message and to the short code, wherein the reply message includes a keyword for charging a transaction cost associated with the transaction request.

In another aspect, some embodiments of the invention provide a method where the confirmation request message includes the keyword.

In another aspect, some embodiments of the invention provide a method of completing a transaction. The method comprises receiving a region identifier and a mobile device identifier; transmitting a transaction request containing the region identifier and the mobile device identifier; receiving a transaction authorization message; and in response to the transaction authorization message, initiating completion of the transaction.

In another aspect, some embodiments of the invention provide a method further comprising receiving a carrier system identifier, where the transmitted transaction request also contains the carrier system identifier.

In another aspect, some embodiments of the invention provide a method where the transaction relates to electronically deliverable content, the transaction authorization message contains a link to the content and wherein, initiating completion of the transaction includes making the content available using the link.

In another aspect, some embodiments of the invention provide a system for conducting a transaction comprising at least one memory and at least one processor configured to perform any of the method steps described herein.

In another aspect, some embodiments of the invention provide a system for completing a transaction configured to perform any of the method steps described herein.

Additional aspects of various embodiments of the invention are identified and described in the following description of some example embodiments of the invention.

### BRIEF DESCRIPTION OF THE DRAWINGS

Several example embodiments of the present invention will now be described with reference to the drawings, in which:

FIG. 1 shows a block diagram of a system in accordance with at least one embodiment of the present invention;

FIG. 2 shows a block diagram of a system in accordance with at least one other embodiment of the present invention;

FIG. 3 shows a block diagram of a system in accordance with at least one other embodiment of the present invention;

FIG. 4 shows a flow diagram of a method in accordance with at least one embodiment of the present invention;

FIG. 5 shows a flow diagram of a method in accordance with at least one other embodiment of the present invention;

FIG. 6 shows a flow diagram of a method in accordance with at least one other embodiment of the present invention;

FIG. 7 shows a flow diagram of a method in accordance with at least one other embodiment of the present invention;

FIG. 8 shows a flow diagram of a method in accordance with at least one other embodiment of the present invention;

FIG. 9 shows a diagram of a graphical user interface of a transaction object in accordance with at least one embodiment of the present invention;

FIG. 10 shows a diagram of a graphical user interface of a transaction object prompting for a transaction request in accordance with at least one other embodiment of the present invention;

FIG. 11 shows a diagram of a graphical user interface of a transaction object displaying a status message in accordance with at least one other embodiment of the present invention;

FIG. 12 shows a front view of a mobile device displaying an example confirmation request message in accordance with at least one other embodiment of the present invention; and

FIG. 13 shows a diagram of a graphical user interface of a transaction object displaying a graphical transaction authorization message in accordance with at least one other embodiment of the present invention.

### DESCRIPTION OF EXEMPLARY EMBODIMENTS

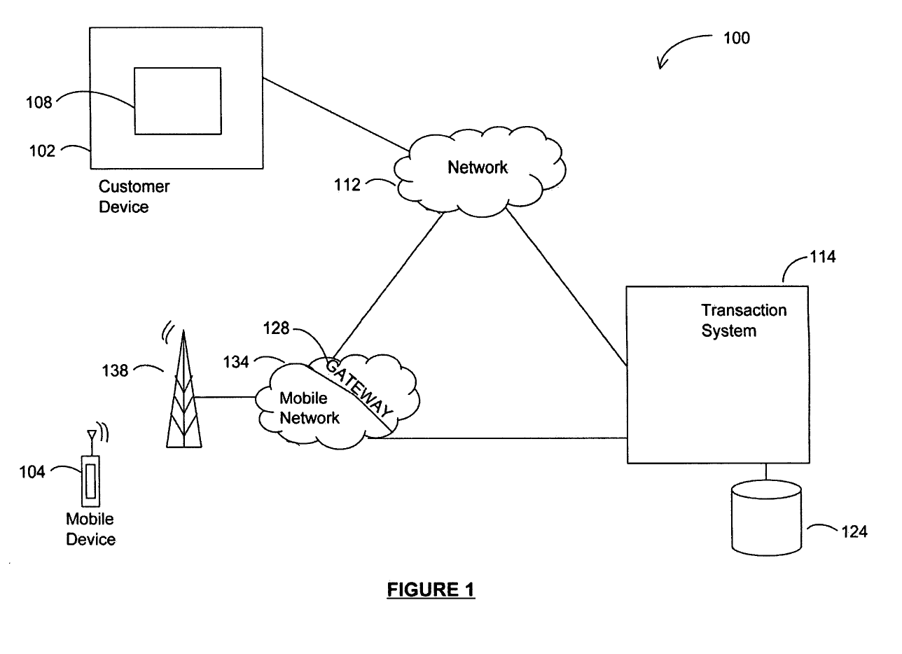

Reference is first made to FIG. 1, which shows a block diagram of a system 100 in accordance with at least one embodiment of the present invention.

The system 100 includes a transaction system 114 that receives a transaction request from a transaction object 108 connected thereto via a network 112. The transaction system 114 transmits a confirmation request message to a mobile device 104 via a mobile network 134 accessed through a gateway 128 and connected to a mobile device base station 138.

The transaction object 108 resides on a customer device 102 connected to a network 112. The transaction object 108 may reside on a mobile device 104, and the customer device may be the mobile device. The transaction system 114 receives a transaction request including a region identifier and a mobile device identifier. The transmitted confirmation request message has an identified short code as a reply address that the transaction system 114 identifies in a short code database 124 based on the region identifier.

Customer device 102 may be any networked computing device including a processor and memory, such as a personal computer, workstation, server, portable computer, mobile phone, personal digital assistant, laptop, smart phone, WAP phone, or a combination of these. Customer device 102 typically includes one or more input devices, such as a keyboard, mouse, camera, touch screen and a microphone, and also includes one or more output devices such as a display screen and a speaker. Customer device 102 has a network interface for connecting to network 112 in order to communicate with other components of system 100 such as transaction system 114.

Transaction object 108 may be any software application, application plug-in (e.g. a widget), instant messaging application, mobile device application, e-mail application, online telephony application, java application, web page, or web object (e.g. a widget) residing or rendered on customer device 102.

Network 112 may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. Network 112 is any network capable of interfacing with and enabling communication between customer device 102 and transaction system 114.

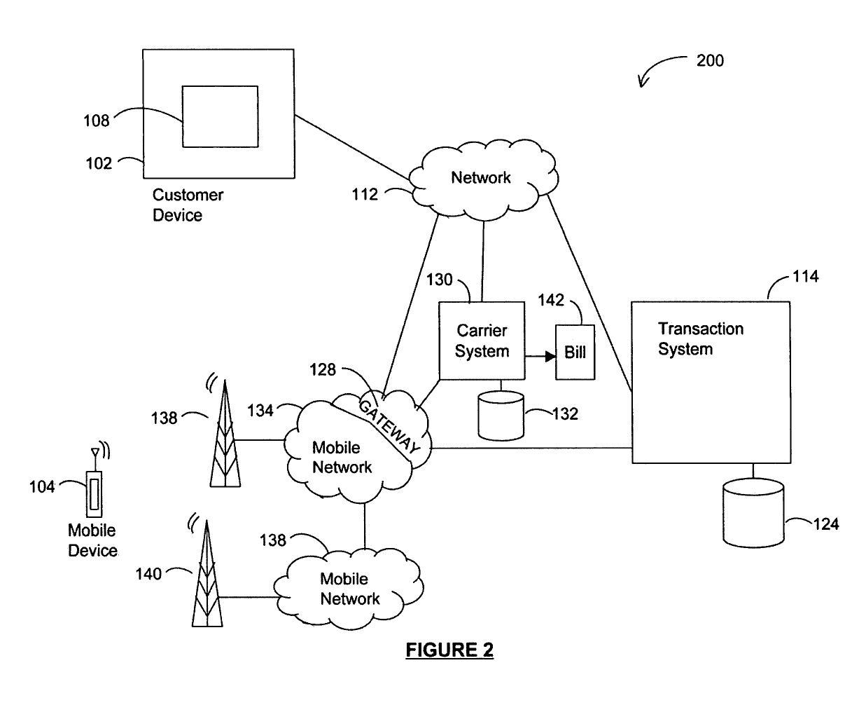

Transaction system 114 is a server system comprising one or more servers (e.g. web servers) with computing processing abilities and memory such as database(s) or file system(s). Although only one transaction system 114 is shown there may be multiple transaction systems 114 distributed over a wide geographic area and connected via e.g. network 112. Transaction system 114 includes a short code database 124 storing a plurality of short codes linked to and indexed by region identifiers. A short code is linked to a region identifier if its digit format is recognizable by at least one carrier system 130 (FIG. 2) in a region associated with the region identifier.

Mobile network 134 may be any mobile, satellite, wireless (e.g. Wi-Fi, WIMAX) fiber, cable or SS7 signaling network (or a combination of these) capable of communicating with mobile device 104 and enabling communication between transaction system 114 and mobile device 104, via e.g. gateway 128 and mobile device base station 138. Mobile network 134 may implement various mobile communication standards such as for example GSM or CDMA. Gateway 128 allows for interfacing with another communication network that uses different standards and/or protocols. While only one mobile network 134 and mobile device base station 138 is shown, multiple mobile networks (e.g. mobile network 138 and mobile device base station 140 of FIG. 2) may be distributed over a geographical area in order to enable communication between transaction system 114 and mobile device 104. Mobile network 134 may be integrated with other networks employing various protocols such as a public switch telephone network (PSTN).

Mobile device 104 may be a mobile phone, a personal digital assistant (PDA), a smart phone, a WAP phone, a satellite phone, a laptop computer or other device that is capable of receiving an SMS or MMS message, and sending an SMS or MMS message to a short code. Mobile device 104 typically includes an antenna, transceiver, processor, memory, one or more input devices (e.g. keypad, mouse, camera, touch screen and a microphone) and also includes one or more output devices (e.g. a display screen and a speaker). Mobile device 103 has networking capabilities for connecting to mobile network 134 and/or network 112. Mobile device 104 may be integrated with and/or form part of customer device 102.

Reference is now made to FIG. 2, which shows a block diagram of a system 200 in accordance with at least one other embodiment of the present invention.

The system 200 further includes a carrier system 130. The carrier system 130 maintains a billing account for the mobile device 104, with associated data stored in the mobile device account database 132. The mobile device account database 132 may contain further information about the mobile device 104 or a user such as a billing or shipping address and payment information. Generally, carrier system 130 is associated with at least one mobile network 138/140 which may be used to enable communication between transaction system 114 and mobile device 104. However, other mobile networks 138/140 may be used to enable communication between transaction system 114 and mobile device 104, such as when for example the mobile device 104 is roaming in a different region or area than carrier system 130 (and its associated mobile networks) the mobile device 104 is associated with.

A mobile device bill 142 may be issued by the carrier system 130 or by a third party service provider (not shown) for usage associated with mobile device 104. For example, if mobile device 104 sends an SMS message to a short code recognizable by mobile network 134 and/or carrier system 130, then a premium rate may be charged to a billing account for the mobile device 104. A mobile device bill 142 may be issued to a mobile device 104 and/or a user associated therewith to enable payment to carrier system 130 for usage by mobile device 104. The premium rate associated with the short code and charged to the billing account of the mobile device 104 may be determined by the carrier system 130 or a third party in agreement with the carrier. The carrier system 130 may in turn provide compensation to a third party for the transaction for charges made in relation to the short code.

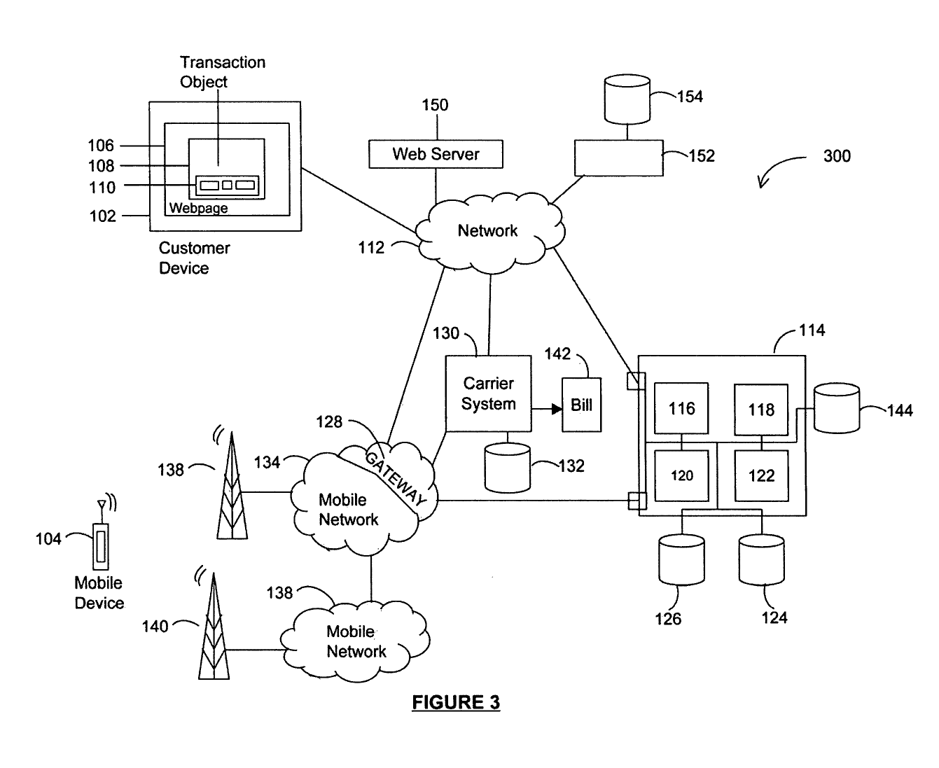

Reference is now made to FIG. 3, which shows a block diagram of a system 300 in accordance with at least one other embodiment of the present invention.

In this example embodiment, transaction object 108 is a widget embedded within a web page 106 served by a web server 150 displayed on a client web browser residing on customer device 102. Web page 106 may display items (e.g. products and/or services) for sale by a merchant or a third party on behalf of a merchant. A merchant may be any product or service provider, supplier, manufacturer, wholesaler, retailer or other person or company that has an interest in the sales or marketing of products and/or services.

A client web browser residing on customer device 102 requests a web page 106 which has a transaction object 108 embedded within. The web page may be hosted by a merchant or other third party for example. The transaction object 108 may include a tag containing a parameter which is used to identify a transaction offer. The web page 106, served by a web server 150, is rendered in the client web browser and the transaction object 108 loads locally in the client web browser. The transaction object 108 opens a connection to the transaction system 114 via network 112, such as for example a hypertext transfer protocol (HTTP) connection.

Transaction system 114 includes a customer device service module 116 for interfacing with transaction object 108, such as e.g. a web service. The transaction object 108 identifying parameter is provided to the customer device service module 116. In response, the customer device service module 116 may provide display or layout attributes which define how the transaction object 108 is rendered on the web page 106 in client web browser on the customer device 102. The display or layout attributes include background, font, images, buttons locations, etc. The display attributes are configurable by a merchant or third party using an interface to the transaction system 114.

When rendered in the client web browser, transaction object 108 includes a transaction request form 110 for receiving a transaction request from a purchaser using an input device of the customer device 102. The transaction request includes a mobile device identifier, such as a mobile device number, and a region identifier such as a country (e.g. Canada) or other territory (e.g. European Union).

The transaction object 108 transmits the transaction request to the transaction system 114. In response, the transaction system 114 identifies a short code in a short code database 124 using the region identifier. The short code database 124 stores a plurality of short codes linked to and indexed by region identifiers. A short code is linked to a region identifier if its digit format is recognizable by at least one carrier system 130 in a region associated with the region identifier.

Message module 118 constructs a confirmation request message, where the reply address is the short code. In accordance with at least one embodiment, message module 118 constructs a confirmation request message, including a confirmation text to authorize or confirm the transaction request. Transaction system 114 may identify data fields in the short code database 124 for use as the confirmation text.

Mobile device service module 120 transmits the confirmation request message to mobile device 104 via mobile network(s) 134/138 and mobile device base station(s) 138/140. The confirmation request message may be in any message format capable of being transmitted to mobile device via mobile network 134 such as an SMS message, an MMS message, e-mail message, instant message, java application, etc.

Mobile device service module 120 may also receive a reply message corresponding to the confirmation request message and the short code. The reply message may be in any message format capable of being transmitted from mobile device via mobile network 134 such as an SMS or MMS message. That is, the reply message has a destination address corresponding to short code for charging a premium rate to a billing account for the mobile device 104 maintained by carrier system 130. A mobile device bill 142 may be issued to mobile device 104 and/or a user associated therewith to enable payment to carrier system 130.

The transaction system 114 may include a record module 122 to assign a transaction identifier to the transaction request. The record module may record the transaction in a transaction database 126 and identify the status of the transaction.

The transaction may relate to electronically deliverable content available from a content server 152 linked to a content database 154, which may be maintained by a merchant or third party content provider. The electronically deliverable content may also be available from a content server 144 maintained by the transaction system 114.

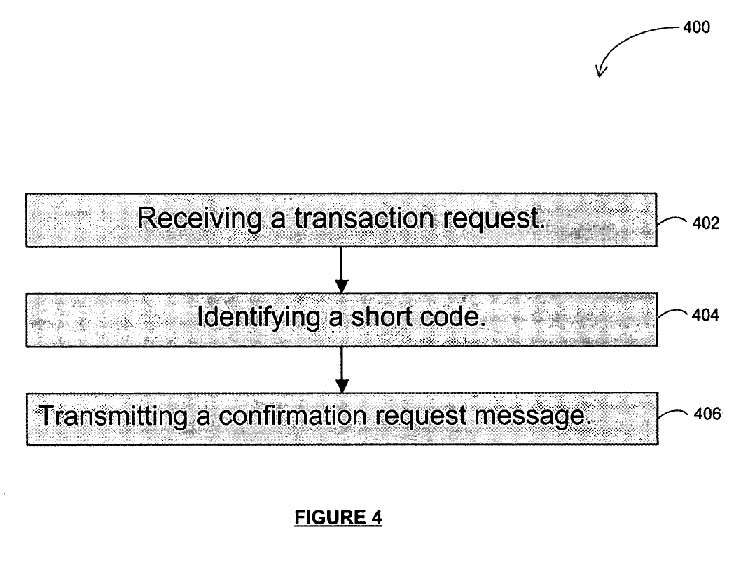

Reference is now made to FIG. 4, which shows a flow diagram of a method in accordance with at least one embodiment of the present invention.

At step 402, the transaction system 114 receives a transaction request from a transaction object 108 via network 112. The transaction request contains a region identifier and a mobile device identifier. For example, the region may be a city, a country, a territory or other geographically defined area. The transaction request may also contain a carrier system identifier, associated with e.g. carrier system 130. As above, carrier system 130 may maintain a billing account associated with mobile device 104. For example, a region may be Canada and a carrier identifier may be Telus™.

The transaction request typically relates to a transaction item. For example, the transaction item may be a product or service. A transaction item identifier relates to the transaction item and may be provided along with the transaction request to transaction system 114.

At step 404, the transaction system 114 identifies a short code in the short code database 124 based on the region identifier. The short code may also be identified based on the carrier system identifier, if for example a region contains numerous carriers and the short code is only recognizable for a sub-set thereof. That is, short codes are indexed in the short code database 124 via region identifier, and sometimes carrier identifier.

The short code allows a premium rate to be charged to the user's mobile device bill 142. The premium rate to charge for an SMS or MMS message sent to the short code is typically determined by a carrier system 130 it is assigned (or leased) to or a third party in agreement with the carrier system 130 responsible for issuing the bill 142. Generally, the premium rate is charged to the user's mobile device bill 142 when the user sends a message to the associated short code.

A third party maintaining transaction system 114 may enter into agreement with the carrier system 130 regarding the premium rate to associate with specific short codes stored in short code database 124.

A third party maintaining transaction system 114 may also enter into agreement with the carrier system 130 to charge a first premium rate for a message sent to a short code if the message contains a first keyword, and a second premium rate for a message sent to the same short code if the message contains a second keyword.

In some instances, the second premium rate may not be a charge to the mobile device bill 142 (i.e. no rate will be charged to bill 142 when a message is sent to the short code by mobile device 142). For example, the mobile device reply may deny or decline a confirmation request message.

This allows for e.g. a dynamic premium rate (and sometimes no rate at all) to be associated with a short code depending on the content of the message sent to the short code. The premium rate may be defined, at least in part, by the transaction cost for the transaction item related to the transaction request.

The plurality of short codes may be stored in the short code database 124 in the form of any data structure suitable for recordal in the short code database 124. Each short code in the short code database may be associated with (or linked to) one or more data fields, such as a region identifier. Other data fields include a transaction item identifier, a carrier identifier, a premium rate, a transaction cost, a keyword, a mobile phone identifier etc. The transaction item identifier relates to a transaction item with an associated transaction cost. The transaction item relates to a transaction request.

The premium rate relates to the amount charged to the bill 142 maintained by carrier system 130 when a message is sent to a short code (linked thereto) by the mobile device 104. The keyword relates to the content of the message sent to a short code by mobile device 104 for use by carrier system 130 for charging a dynamic premium rate for the short code, as explained. In some instances, the keyword may be equivalent to the transaction item identifier.

Each short code may be indexed in the short code database 124 by one or more of the associated data fields. An index provides a means for the transaction system 114 to identify a short code in the short code database 124 based on a data field value, such as e.g. a region identifier value, a transaction cost value or a keyword value. For example, transaction system 114 may receive a transaction request relating to a transaction item with an associated transaction cost value.

Transaction system 114 may use the transaction cost value to identify a short code linked to a transaction cost (data field) corresponding to the transaction cost value. As a short code is used to charge a mobile device bill 142 this may enable the premium rate charged to bill 142 associated with mobile device 104 to be defined at least in part by transaction cost.

Upon identifying a short code in the short code database 124, one or more of the data fields linked thereto may also be identified. One or more of the data fields linked to the short code may be included in the confirmation request message sent to mobile device 104. For example, if a short code has a dynamic premium rate, then a keyword linked thereto may also be identified. If the short code is identified using e.g. a region identifier and a transaction cost, then the keyword linked thereto may also be identified. The keyword in turn may affect the premium rate charged to the mobile device bill 142, as explained above.

Referring to the table below, a simplified example is illustrated. If the regional identifier of the received transaction request is “United States”, then the short code “223344” will be identified in the short code database 124. The transaction request may relate to a transaction item with an associated transaction cost value of $3.00, which may also be used to identify the short code 223344. Both the transaction cost and regional identifier may be used to identify the keyword SONG linked to 223344. The premium rate charged to the bill 142 associated with mobile device 104 may be a different amount than the transaction cost in order to e.g. provide a service fee to carrier system 130.

| Short Code | Keyword | Transaction Cost | Regional Identifier |
|---|---|---|---|
| 223344 | SONG | $2.00 | United States |
| 223344 | VIDEO | $3.00 | United States |

At step 406, the transaction system 114 transmits a confirmation request message to a mobile device corresponding to the mobile device identifier, wherein the confirmation request message includes a reply address corresponding to the short code. When the mobile device 104 sends a reply message to the short code carrier system 130 generally charges an account associated therewith.

The transaction system 114 includes message module 118 which constructs the confirmation request message for transmission to mobile device 104. The confirmation request message typically contains confirmation text indicating how the mobile device can confirm or authorize the transaction request. For example, the confirmation text may be Y/N type content or may be a transaction identifier (e.g. “PROD12”) or keyword (e.g. “SONG”). The confirmation request message may also include informative text, such as customer support contact details.

The transaction system 114 may maintain a mobile device database containing information records indexed by mobile device identifiers. An information record relating to the mobile device identifier of the transaction request may be identified by message module 118 and used to construct the confirmation request message.

Mobile device service module 120 transmits the confirmation request message to mobile device 104 via mobile network(s) 134/138 and mobile device base station(s) 138/140. The confirmation request message may be an SMS or MMS message, or other format as noted herein.

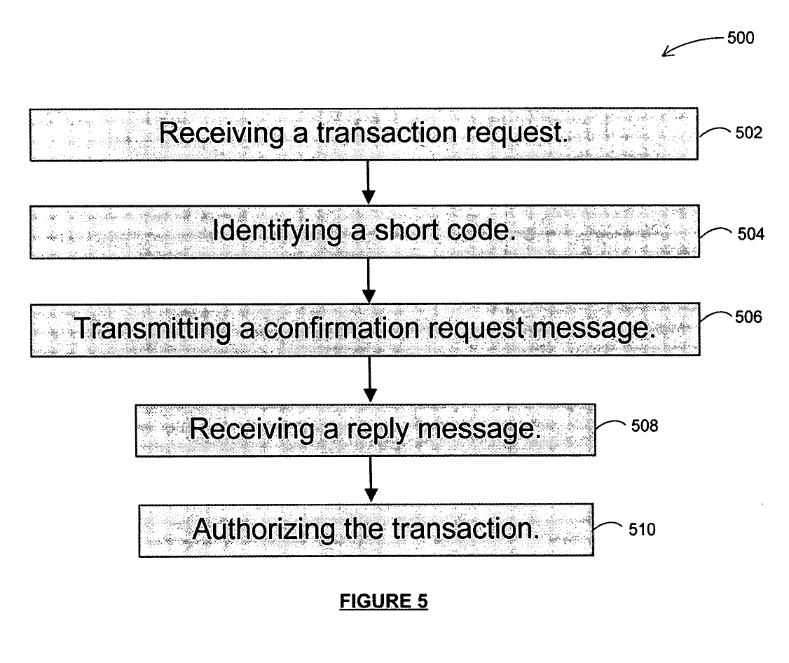

Reference is now made to FIG. 5, which shows a flow diagram of a method in accordance with at least one other embodiment of the present invention. Generally, steps 502 to 506 are as described in relation to steps 402 to 406 of FIG. 4 and will not be repeated in detail so as not to obscure from the additional features of the at least one embodiment.

At step 508, the transaction system 114 receives a reply message corresponding to the confirmation request message and to the short code. When the mobile device 104 sends a reply message to the short code, carrier system 130 generally charges an account associated therewith. The short code allows a premium rate to be charged to an account linked to mobile device 104 for issuing bill 142. This premium rate may be defined, at least in part by, the transaction cost or keyword.

In at least one embodiment, mobile device service module 120 polls for all incoming messages (e.g. reply messages) to transaction system 114 transmitted from mobile device(s) 104 via mobile network 134.

In at least one embodiment, the reply message corresponding to the confirmation request message may include a reply text. The reply text may indicate authorization or confirmation of the transaction request. The reply text may correspond, at least in part, to the confirmation text indicating how the mobile device can confirm or authorize the transaction request in the reply message.

For example, the confirmation text may be Y/N type content and the reply text of a reply message authorizing or confirming the transaction request may include Y. As another example, the confirmation text may include one or more of the data fields associated with the transaction record (e.g. a transaction identifier or keyword) and the reply text may include the data field(s). A keyword may be linked to a dynamic premium rate for the short code.

In at least one embodiment, the reply message may include a reply text indicating denial of the transaction request. For example, a reply message denying the transaction request may include N as a reply text.

In at least one embodiment, the reply message may not include reply text.

At step 510, the transaction system 114 authorizes the transaction in response to the reply message. As will be explained herein, authorizing the transaction may encompass a variety of actions and events. For example, if the transaction request relates to electronically deliverable content, then upon authorization it may be available for download to customer device 102 or mobile device 104 by providing a link to the content. This link may be transmitted to another party such as via a message (e.g. SMS, MMS, e-mail, etc.).

If the transaction request relates to a service, then upon authorization the service may be provided to a purchaser. If the transaction request relates to a physically deliverable item, then upon authorization the item may be shipped or otherwise delivered to a purchaser.

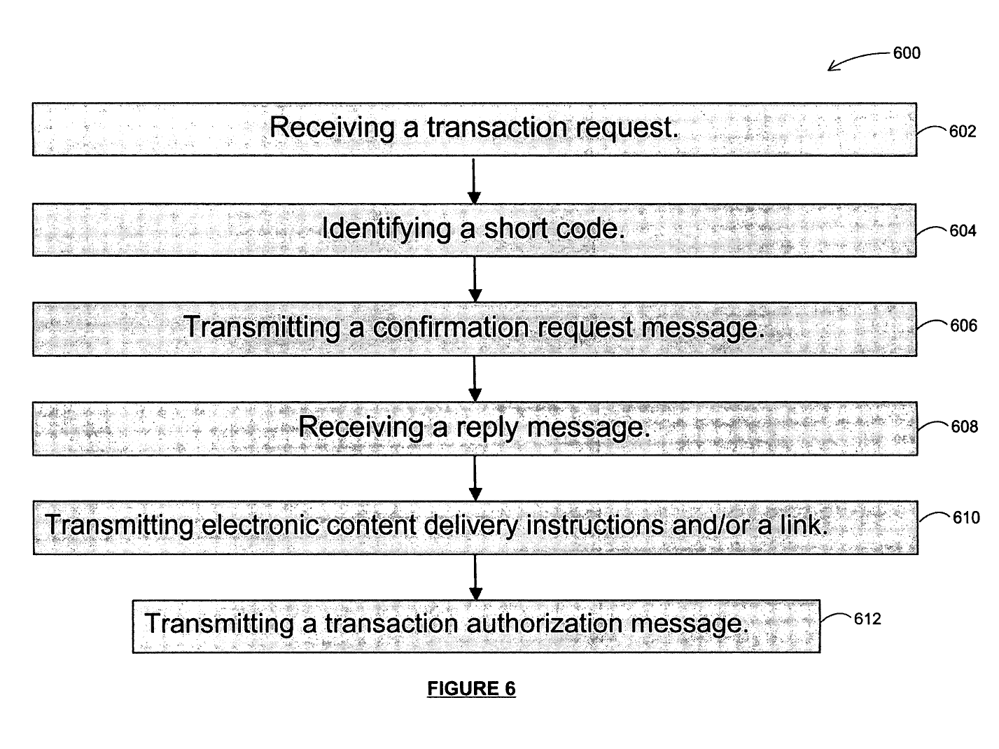

Reference is now made to FIG. 6, which shows a flow diagram of a method in accordance with at least one other embodiment of the present invention. Generally, steps 602 to 606 are as described in relation to steps 402 to 406 of FIG. 4 and will not be repeated in detail so as not to obscure from the additional features of the at least one embodiment.

The transaction may relate to electronically deliverable content available from a content server 152 linked to a content database 154 (FIG. 3). The electronically deliverable content may also be available from a content server 144 maintained by the transaction system 114. Examples of electronically deliverable content include: software, music, video, audio, ebooks, images, files, journals, images, photographs, an access code, ring tones, video game virtual products, virtual currency (e.g. game currency), avatars, electronic payment, electronic tickets, electronic vouchers, and the like.

At step 608, the transaction system 114 receives a reply message corresponding to the confirmation request message and to the short code. When the mobile device 104 sends a reply message to the short code, carrier system 130 generally charges an account associated therewith. The short code allows a premium rate to be charged to an account linked to mobile device 104 for issuing bill 142. This premium rate may be defined, at least in part by, the transaction cost or keyword.

In at least one embodiment, mobile device service module 120 polls for all incoming messages (e.g. reply messages) to transaction system 114 transmitted from mobile device(s) 104 via mobile network 134.

In at least one embodiment, the reply message corresponding to the confirmation request message may include a reply text. The reply text may indicate authorization or confirmation of the transaction request. The reply text may correspond, at least in part, to the confirmation text indicating how the mobile device can confirm the transaction request in the reply message.

For example, the confirmation text may be Y/N type content and the reply text of a reply message authorizing or confirming the transaction request may include Y. As another example, the confirmation text may include one or more of the data fields associated with the transaction record (e.g. a transaction identifier or keyword) and the reply text may include the data field(s). A keyword may be linked to a dynamic premium rate for the short code.

In at least one embodiment, the reply message may include a reply text indicating denial of the transaction request. For example, a reply message denying the transaction request may include N as a reply text.

In at least one embodiment, the reply message may not include reply text.

At step 610, the transaction system 114 transmits electronic content delivery instructions to content server 152 linked to content database 154 storing the electronically deliverable content. Content server 152 may be maintained by a third party content provider or by a merchant associated with web page 106. Electronically deliverable content may also be stored in content database 144 and the electronic content delivery instructions are transmitted within transaction system 114, which acts as a content server. Electronic content delivery instructions may indicate what electronic content to deliver by indicating e.g. a content identifier. The electronic content delivery instructions may also indicate how the content should be electronically delivered, such as via a download (e.g. made available for download or transmitted) to customer device 102 and/or mobile device 104, by streaming to customer device 102 and/or mobile device 104, or via a link.

The electronic content delivery instructions may also indicate an access code (e.g. user name, login, password) for input by e.g. a user using an input device of the customer device 102 to access electronic content controlled by a security interface form that is unlocked using the access code. For example, a subscription to an electronic journal may require an access code to be provided using input devices of customer device 102 in order to view electronic journal articles. As another example, transaction system 114 may include a web server to serve a web page including a security interface form. Upon receiving the access code as input, the electronic content may be available for download or accessible to customer device 102 and/or mobile device 104.

The electronic content delivery instructions may also indicate a keyword for allowing different pricing systems or services.

Alternatively, the transaction system 114 may transmit a transaction authorization message to the transaction object 108, wherein the transaction authorization message instructs the transaction object 108 to deliver the content to a purchaser. The transaction authorization message may indicate an access code. The transaction authorization message may instruct what electronic content to deliver, how the content should be electronically delivered (e.g. available for download, transmit, provide a link or stream) and when the content should be electronically delivered (e.g. periodically or one time only).

At step 612, the transaction system 114 transmits a transaction authorization message to the transaction object 108. The transaction authorization message may indicate to the transaction object 108 that electronic content delivery instructions have been transmitted to the content server 152. The transaction object 108 may request delivery of the electronic content from the content server 152 to customer device 102. The transaction object 108 may provide a message to output device(s) of customer device 102 to e.g. display that the transaction request has been authorized.

In at least one embodiment, the transaction system 114 may only transmit a transaction authorization message to the transaction object 108, wherein the transaction authorization message includes a link or url to the electronically deliverable content. The link or url may be indicated by output device of customer device 102, e.g. via display screen. The location defined by the link or url may be pertain to content server 152 (linked to content database 154) or content database 144 of transaction system 114.

In at least one embodiment, upon transmitting the original transaction request to transaction system 114, transaction object 108 polls (or calls) e.g. the customer device service module 144 requesting a transaction authorization message until it is transmitted. The transaction object 108 may poll (or call) the customer device service module 144 periodically at predetermined time periods. For example, transaction object 108 may poll (or call) the customer device service module 144 every 15 seconds for a transaction authorization message. If the transaction object 108 is embedded within web page 106 in a client web browser, then the transaction object 108 may only poll for a transaction authorization message if the client web browser session has not be terminated on client device 102.

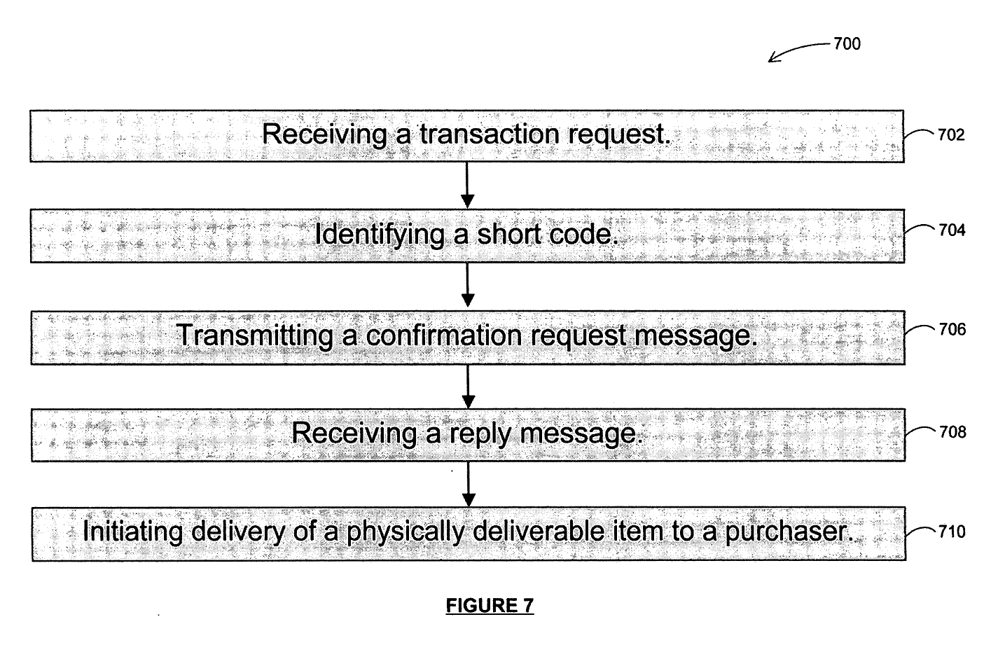

Reference is now made to FIG. 7, which shows a flow diagram of a method in accordance with at least one other embodiment of the present invention. Generally, steps 702 to 706 are as described in relation to steps 402 to 406 of FIG. 4 and will not be repeated in detail so as not to obscure from the additional features of the at least one embodiment.

The transaction may relate to a physically deliverable item, such as merchandise, books, property, stocks, services, raw materials, computer readable medium with electronic content stored thereon, and any other physical (or tangible) item that can be a subject of a transaction and delivered.

At step 708, the transaction system 114 receives a reply message corresponding to the confirmation request message and to the short code. When the mobile device 104 sends a reply message to the short code, carrier system 130 generally charges an account associated therewith. The short code allows a premium rate to be charged to an account linked to mobile device 104 for issuing bill 142. This premium rate may be defined, at least in part by, the transaction cost or keyword.

In at least one embodiment, mobile device service module 120 polls for all incoming messages (e.g. reply messages) to transaction system 114 transmitted from mobile device(s) 104 via mobile network 134.

In at least one embodiment, the reply message corresponding to the confirmation request message may include a reply text. The reply text may indicate authorization or confirmation of the transaction request. The reply text may correspond, at least in part, to the confirmation text indicating how the mobile device can confirm the transaction request in the reply message.

For example, the confirmation text may be Y/N type content and the reply text of a reply message authorizing or confirming the transaction request may include Y. As another example, the confirmation text may include one or more of the data fields associated with the transaction record (e.g. a transaction identifier or keyword) and the reply text may include the data field(s). A keyword may be linked to a dynamic premium rate for the short code.

In at least one embodiment, the reply message may include a reply text indicating denial of the transaction request. For example, a reply message denying the transaction request may include N as a reply text.

In at least one embodiment, the reply message may not include reply text.

At step 710, the transaction system 114 initiates delivery of the item to a purchaser. The purchaser may be associated with mobile device 104 and may have provided the original transaction request using input device(s) of the customer device 102. The item may be any tangible product and/or one or more services. In the case of a tangible product, initiating delivery may include sending delivery instructions to a third party product provider for shipment, distribution or other means of provision to the purchaser associated with mobile device 104. In at least one embodiment, the purchaser is the user associated with mobile device 104. In such case, transaction system 114 may request billing or shipping information (such as an address) associated with mobile device 104 from carrier system 130. The billing or shipping information (such as an address) associated with mobile device 104 is provided to a product or service provider for delivery of the product or service to the purchaser (i.e. the user associated with the mobile device 104).

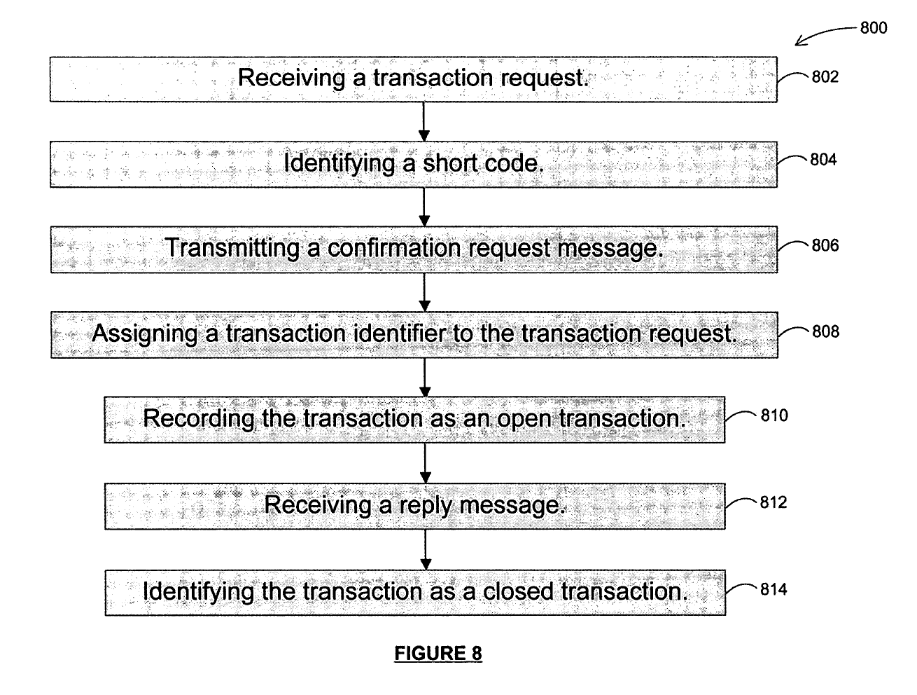

Reference is now made to FIG. 8, which shows a flow diagram of a method in accordance with at least one other embodiment of the present invention. Generally, steps 802 to 806 are as described in relation to steps 402 to 406 of FIG. 4 and will not be repeated in detail so as not to obscure from the additional features of the at least one embodiment.

At step 808, the transaction system 114 assigns a transaction identifier to the transaction request. The transaction identifier may uniquely identify the transaction request such as a unique numerical or text code. The transaction identifier may include the mobile device identifier or a mobile device number associated therewith. In the event that more than one transaction request includes the same mobile device identifier, then more than one transaction request may be linked to the same transaction identifier. Alternatively, a tag or code may be affixed to the mobile device identifier to ensure that each transaction request is linked to a unique transaction identifier. The transaction identifier associated with the transaction request may be included in the confirmation request message sent to the mobile device 104 or the reply message received from the mobile device 104.

At step 810, the transaction system 114 records the transaction in a transaction database 126 using e.g. record module 120. Record module 120 manages transaction database 126 by recording transactions therein and by identifying transactions recorded in the transaction database 126.

The recorded transaction may take the form of any data structure suitable for recordal in the transaction database 126, and for ease of reference will be referred to herein as a transaction record. The transaction record includes data fields linked to transaction request, such as the transaction identifier or the mobile phone identifier. Other data fields include a transaction item identifier, carrier identifier, region identifier, a user identifier, transaction cost, a credibility score linked to the mobile device identifier, a date of the transaction request (e.g. date stamp), a time of the transaction request (e.g. time stamp) etc. The transaction record may be indexed in the transaction database 126 by any of the associated data fields, such as for example the transaction identifier, the mobile phone identifier, and the transaction item identifier. An index provides a means for record module 122 to identify the transaction record in the transaction database 126 based on a data field value, such as e.g. a transaction identifier value or mobile device identifier value.

The transaction record may include a data field relating to the status of the transaction, which may also be used as an index. When the transaction is first recorded in the transaction database 126 as a transaction record, generally the status data field is set to open. That is, the transaction system 114, and in particular record module 122, identifies the transaction recorded in the transaction database 126 as an open transaction.

One or more of the data fields of the transaction record associated with the transaction request may be included in the confirmation request message sent to mobile device 104.

At step 812, the transaction system 114 receives a reply message corresponding to the confirmation request message and to the short code. When the mobile device 104 sends a reply message to the short code, carrier system 130 generally charges an account associated therewith. The short code allows a premium rate to be charged to an account linked to mobile device 104 for issuing bill 142. This premium rate may be defined, at least in part by, the transaction cost or keyword.

In at least one embodiment, mobile device service module 120 polls for all incoming messages (e.g. reply messages) to transaction system 114 transmitted from mobile device(s) 104 via mobile network 134.

In at least one embodiment, the reply message corresponding to the confirmation request message may include a reply text. The reply text may indicate authorization or confirmation of the transaction request. The reply text may correspond, at least in part, to the confirmation text indicating how the mobile device can confirm the transaction request in the reply message.

For example, the confirmation text may be Y/N type content and the reply text of a reply message authorizing or confirming the transaction request may include Y. As another example, the confirmation text may include one or more of the data fields associated with the transaction record (e.g. a transaction identifier or keyword) and the reply text may include the data field(s). A keyword may be linked to a dynamic premium rate for the short code.

In at least one embodiment, the reply message may include a reply text indicating denial of the transaction request. For example, a reply message denying the transaction request may include N as a reply text.

In at least one embodiment, the reply message may not include reply text.

At step 814, the transaction system 114 identifies the transaction corresponding to the confirmation request message as a closed transaction. In particular, the record module 122 may identify the transaction record corresponding to the confirmation message in the transaction database 126 and sets the status data field to closed.

In at least one embodiment, in response to receiving a reply message corresponding to the confirmation request message and to the short code, the transaction system 114 identifies the mobile device 104 that the reply message was received from. The transaction system 114 may use e.g. mobile device service module 120 to monitor incoming reply messages received via mobile network 134. The transaction system 114 may identify the mobile device 104 using an associated mobile device number or mobile device identifier.

Upon identifying the mobile device identifier associated with the reply message, the transaction system 114 provides the mobile device identifier to record module 122 to identify a corresponding transaction record recorded in transaction database 126.

The reply text of the reply message may be processed by transaction system 114. The reply text may indicate authorization or confirmation of the corresponding confirmation request message. The reply text may include one or more of the data fields associated with the transaction record (e.g a transaction identifier, keyword, Y/N type content) which may be used by record module 122 to identify the transaction record corresponding to the reply message in addition or as an alternative to the mobile device identifier.

The transaction records recorded in the transaction database 126 may be indexed by a data field (e.g. the mobile device identifier corresponding to the transaction request) and identified using a data field value (e.g. mobile device identifier corresponding to the reply message). When the corresponding transaction record is identified, record module 122 sets to the status to closed.

The reply text may be used by record module 122 to set the status of the transaction record. For example, a reply message authorizing or confirming the transaction request may include Y as a reply text. In response, the record module 122 may set to the status of the transaction record to authorized or confirmed, in addition or in alternative to closed. As another example, the reply message may include a reply text indicating denial of the transaction request. A reply message denying or declining the transaction request may include N as a reply text. In response, the record module 122 may set to the status of the transaction record to denied or declined, in addition or in alternative to closed.

If more than one transaction request corresponds to a mobile device identifier, then the confirmation text and the corresponding reply text may vary slightly between confirmation request messages in order to indicate authorization or denial of the corresponding transaction request. This may be required if the mobile device identifier is used to identify the transaction record in the transaction database 126. For example, a first confirmation request message may have as a confirmation text Y1 and a second confirmation request message may have as a confirmation text Y2, where both confirmation request messages are associated with the same mobile device identifier. If the reply text contains Y1 then the reply message would correspond to the first confirmation request message. If the reply text contains Y2 then the reply message would correspond to the second confirmation request message.

The confirmation text associated with the confirmation request message corresponding to the mobile device identifier may be a data field in the transaction record. This may allow the record module 122 to identify the transaction record using the reply text and/or confirmation text.

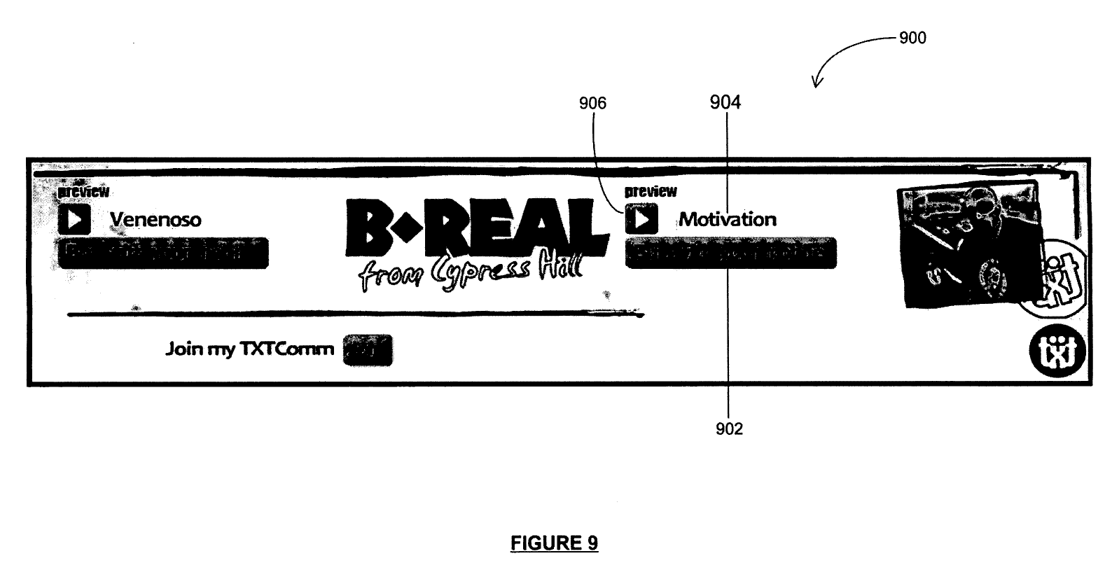

An illustrative example of at least one embodiment of the present invention will now be described with reference to FIGS. 9 to 13.

Reference is first made to FIG. 9, which shows a diagram of a graphical user interface 900 of a transaction object 108 in accordance with at least one embodiment of the present invention.

The graphical user interface 900 of the transaction object 108 comprises a transaction request link 902 to initiate a transaction request. In this example, the transaction relates to electronically deliverable content and in particular to a digital music file entitled “Motivation” as illustrated by a display title 904. The preview link 906 enables a purchaser using customer device 102 to preview the electronically deliverable content via output device(s) of customer device 102, and in particular via e.g. speakers. Upon selection of the preview link 906 a portion of the electronically deliverable content is delivered to the customer device 102 by e.g. downloading or streaming the digital music file to which the transaction relates. Transaction object 108 enables a purchaser to preview the electronically deliverable content prior to conducting a transaction.

In this example embodiment, transaction object 108 is a widget embedded within a web page 106 (not shown) rendered on a client web browser residing on customer device 102 and served by a web server 150 connected to customer device 102 via network 112.

A purchaser may select the transaction request link 902 using input device(s) of customer device 102 such as e.g. a mouse. Selection of the transaction request link 902 initiates a transaction request by prompting the purchaser for a transaction request.

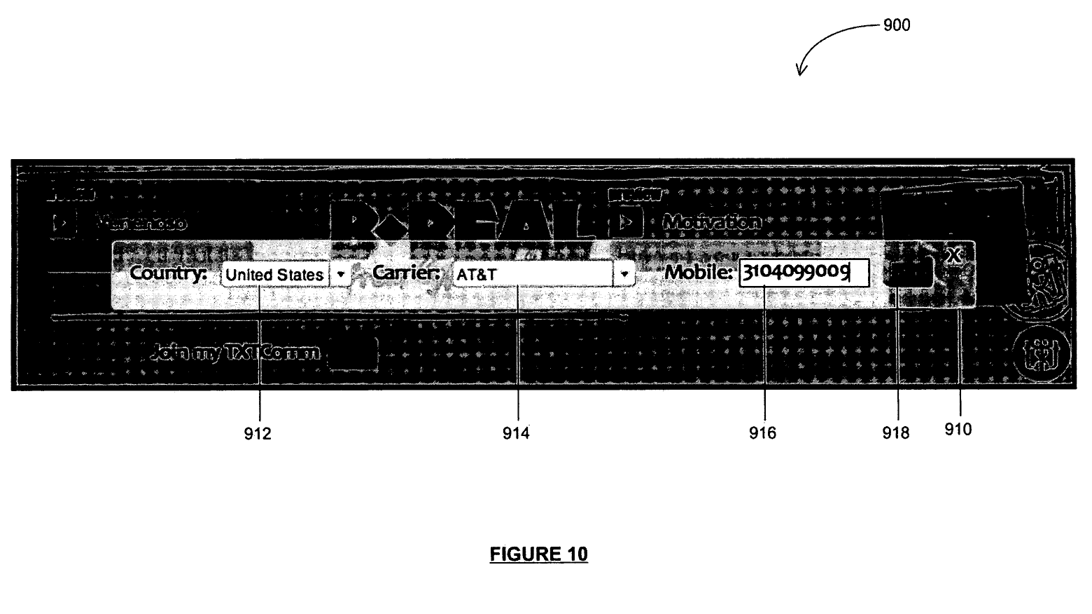

Reference is now made to FIG. 10, which shows a diagram of a graphical user interface 900 of a transaction object 108 prompting for a transaction request in accordance with at least one other embodiment of the present invention.

When rendered in the client web browser, the graphical user interface 900 of a transaction object 108 includes a graphical user interface 910 of a transaction request form 110 for receiving a transaction request from a purchaser using an input device of a customer device 102. In this example, the transaction request form 110 comprises a region selection module 912, a carrier selection module 914, and a mobile device identifier input module 916, and a transaction request transmission link 910.

The region selection module 912 enables selection of the region identifier of the transaction request from a set of region identifiers (not shown) displayed on customer device via a drop down combo box. The set of region identifiers may be transmitted to transaction object 108 by transaction system 114 for populating the region selection module 912.

The carrier selection module 914 enables selection of the carrier identifier of the transaction request from a set of carrier identifiers (not shown) displayed on customer device via a drop down combo box. In accordance with at least one embodiment, upon selection of a region identifier using region selection module 912, the selected region identifier is transmitted to transaction system 108 and forms part of the transaction request. Using the region identifier of the transaction request, the transaction system 108 identifies a set of carrier identifiers. The set of carrier identifiers may be transmitted to transaction object 108 by transaction system 114 for populating the carrier selection module 914.

The mobile device identifier input module 916 enables a purchaser using input device(s) of customer device 102 such as e.g. a key board to input a mobile phone identifier, which also forms part of the transaction request.

In this example, the transaction request includes a region identifier such as a country (United States), a carrier identifier (AT&T), and a mobile device identifier, such as a mobile device number (3104099009).

The transaction request transmission link 918 of graphical user interface 910 of the transaction request form 110 may be activated (or selected) by a purchaser using input device(s) of customer device 102 such as e.g. a mouse to activate transmission of the transaction request to transaction system 114.

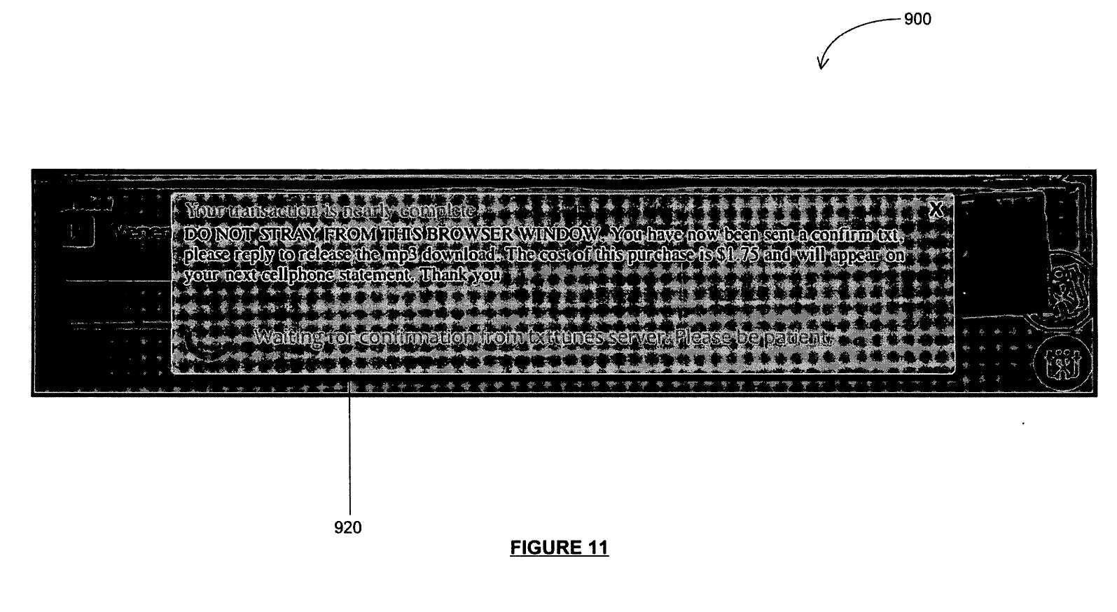

Reference is now made to FIG. 11, which shows a diagram of a graphical user interface 900 of a transaction object 108 providing a status message 920 in accordance with at least one other embodiment of the present invention. The status message 920 may be displayed on output device, e.g. display, of customer device within the graphical user interface 900 of a transaction object 108. The status message 920 may be displayed until the transaction is authorized by transaction system 114, such as at e.g. step 510 of FIG. 5 or step 612 of FIG. 6.

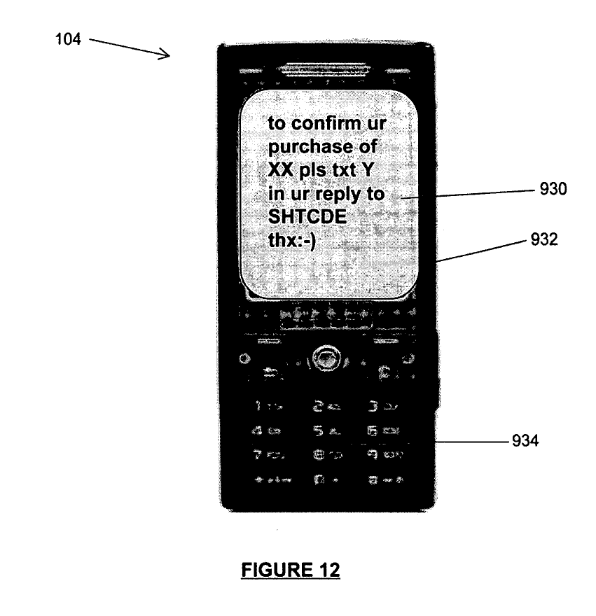

Reference is now made to FIG. 12, which shows a front view of a mobile device 104 displaying an example confirmation request message 930 in accordance with at least one other embodiment of the present invention. As shown, the mobile device 104 comprises an output device 932, and in particular a display screen, and an input device 934, and in particular a keypad. The example confirmation request message 930 states “to confirm ur purchase of XX pls txt Y in ur reply to SHTCDE thx :-)”. In this example, the confirmation text of the example confirmation request message 930 is “Y” and the short code is “SHTCDE”. A reply message (not shown) authorizing or confirming the transaction would have a destination address as “SHTCDE” and a reply text as “Y”.

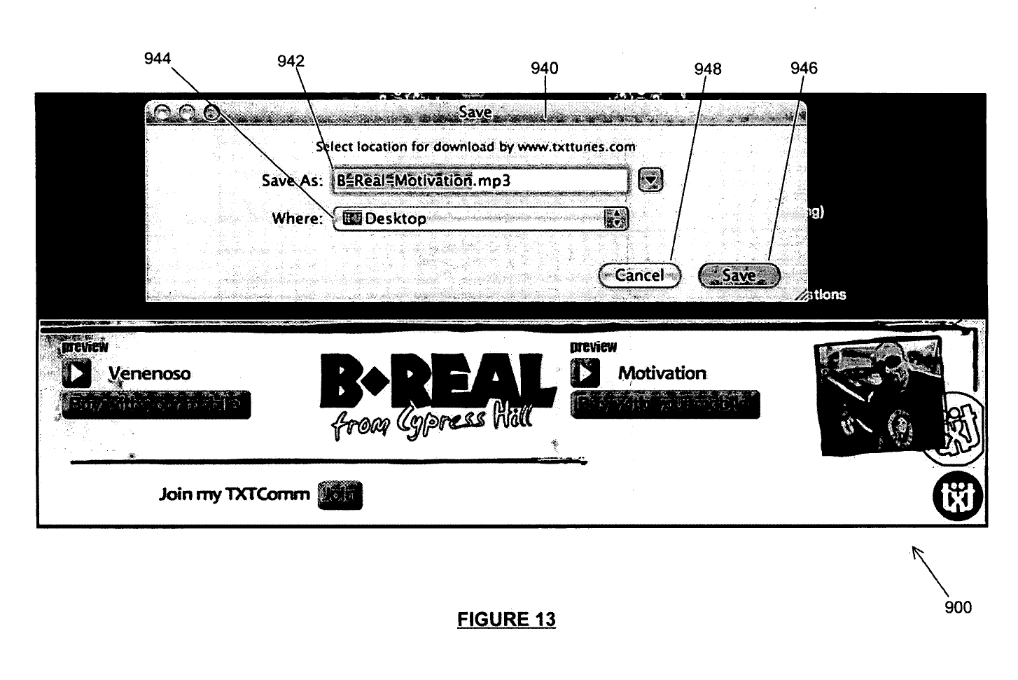

Reference is now made to FIG. 13, which shows a diagram of a graphical user interface 900 of a transaction object 108 displaying a graphical transaction authorization message 940 for enabling delivery of the electronically deliverable content to customer device 102.

As above, upon receiving a reply message from mobile device 104 the transaction system 114 transmits a transaction authorization message (e.g. a message in HTML format) to the transaction object 108. The graphical transaction authorization message 940 includes a link to the electronically deliverable content, which in this example is a digital music file 942 entitled “B-Real-Motivation.mp3”. The location defined by the link may be pertain to content server 152 (linked to content database 154) or content database 144 of transaction system 114. A purchaser using an input device of customer device 102 may select a location using a location selection module 944 to indicate where in the memory of customer device 102 the digital music file 942 should be downloaded. Upon activating a delivery link 946 using input device of the customer device 102 the digital music file 942 is downloaded to customer device 102. In particular, transaction object 108 navigates to the address associated with the link to the electronically deliverable content. Alternatively, a cancellation link 948 may be activated in order to cancel a delivery of the digital music file 942.

The embodiments of the present invention relate to methods and systems for conducting a transaction. The transaction system 114 receives a transaction request from a transaction object 108 containing a region identifier and a mobile device identifier. The transaction system 114 identifies a short code based on the region identifier. Then, the transaction system 114 transmits a confirmation request message to a mobile device 104 corresponding to the mobile device identifier, wherein the confirmation request message includes a reply address corresponding to the short code.

The present invention has been described here by way of example only. Various modification and variations may be made to these exemplary embodiments without departing from the spirit and scope of the invention, which is limited only by the appended claims.

We claim:

1. A method for conducting a transaction, the method comprising:
receiving a transaction request from a transaction object containing a region identifier and a mobile device identifier;
identifying a short code based on the region identifier; and
transmitting a confirmation request message to a mobile device corresponding to the mobile device identifier, wherein the confirmation request message includes a reply address corresponding to the short code.

2. The method of claim 1 wherein the transaction request also contains a carrier system identifier and wherein the short code is identified based on both the region identifier and the carrier system identifier.

3. The method of claim 1 further comprising:
receiving a reply message corresponding to the confirmation request message and to the short code; and
authorizing the transaction in response to the reply message.

4. The method of claim 1 wherein the transaction relates to electronically deliverable content available from a content server and the method further comprises:
receiving a reply message corresponding to the confirmation request message and to the short code;
transmitting electronic content delivery instructions to the content server; and
transmitting a transaction authorization message to the transaction object.

5. The method of claim 1 wherein the transaction relates to electronically deliverable content and the method further comprises:
receiving a reply message corresponding to the confirmation request message and to the short code;
transmitting a transaction authorization message to the transaction object, wherein the transaction authorization message instructs the transaction object to deliver the content to a purchaser.

6. The method of claim 1 wherein the transaction relates to electronically deliverable content and the method further comprises:
receiving a reply message corresponding to the confirmation request message and to the short code; and
transmitting a transaction authorization message to the transaction object, wherein the transaction authorization message includes a link to the electronically deliverable content.

7. The method of claim 1 wherein the transaction relates to a physically deliverable item and the method further comprises:
receiving a reply message corresponding to the confirmation request message and to the short code; and
initiating delivery of the item to a purchaser.

8. The method of claim 1 further comprising:
assigning a transaction identifier to the transaction request;
recording the transaction in a transaction database; and
identifying the transaction as an open transaction.

9. The method of claim 8 further comprising:
receiving a reply message corresponding to the confirmation request message and to the short code;
identifying the transaction corresponding to the confirmation request message as a closed transaction.

10. The method of claim 1 wherein the confirmation request message includes a transaction identifier.

11. The method of claim 1 wherein the confirmation request message includes a transaction identifier, and wherein the reply message includes the transaction identifier.

12. The method of claim 1 wherein the transaction object is embedded within a merchant web page rendered on a customer device.

13. The method of claim 2 wherein the carrier system identifier corresponds to a carrier system, and wherein the short code corresponds to a transaction cost for charging an account associated with the mobile device maintained by the carrier system.

14. The method of claim 1 further comprising:
receiving a reply message corresponding to the confirmation request message and to the short code, wherein the reply message includes a keyword for charging a transaction cost associated with the transaction request.

15. The method of claim 14 wherein the confirmation request message includes the keyword.

16. A method of completing a transaction, the method comprising:
receiving a region identifier and a mobile device identifier;
transmitting a transaction request containing the region identifier and the mobile device identifier;
receiving a transaction authorization message; and
in response to the transaction authorization message, initiating completion of the transaction.

17. The method of claim 16 further including
receiving a carrier system identifier,
wherein the transmitted transaction request also contains the carrier system identifier.

18. The method of claim 16 wherein the transaction relates to electronically deliverable content, the transaction authorization message contains a link to the content and wherein, initiating completion of the transaction includes making the content available using the link.

19. A system for conducting a transaction, the system comprising at least one memory and at least one processor configured to perform the method steps of claim 1.

20. A system for conducting a transaction, the system comprising at least one memory and at least one processor configured to perform the method steps of claim 8.
